(19) United States
(12) Patent Application Publication
(10) Pub. No.: US 2013/0122367 A1
(43) Pub. Date: May 16, 2013

(54) LITHIUM PRIMARY CELL

(71) Applicants: Yu Otsuka, Osaka (JP); Nobuhiko Hojo, Osaka (JP)

(72) Inventors: Yu Otsuka, Osaka (JP); Nobuhiko Hojo, Osaka (JP)

(73) Assignee: PANASONIC CORPORATION, Osaka (JP)

(21) Appl. No.: 13/812,316

(22) PCT Filed: Nov. 9, 2011
(86) PCT No.: PCT/JP2011/006275

§ 371 Date: Jan. 25, 2013

(30) Foreign Application Priority Data
Nov. 10, 2010 (JP) 2010-251787

(51) Int. Cl. H01M 4/60; H01M 4/50

(52) U.S. Cl. CPC H01M 4/606; H01M 4/50
USPC 429/213; 252/500; 252/519.33

(57) ABSTRACT

The lithium primary battery of the present invention includes a positive electrode including a first active material capable of absorbing lithium ions and a second active material capable of absorbing and desorbing lithium ions. The second active material is automatically charged by the first active material while the lithium primary battery is in an open circuit state. The first active material is, for example, graphite fluoride or manganese dioxide. The second active material is, for example, an organic compound having two or more ketone groups in a molecule. The second active material may be a polymer.

### TECHNICAL FIELD

The present invention relates to lithium primary batteries.

### BACKGROUND ART

Lithium primary batteries have high energy densities, are highly reliable in terms of storage stability, etc., and are capable of being reduced in size and weight. Because of these advantages, the demand for lithium primary batteries is increasing year after year as main power sources for various electronic devices and as power sources for memory backup. In recent years, lithium primary batteries have been expected to extend their application into the automobile sector, for example, for use in smart keys (registered trademark). Under these circumstances, lithium primary batteries are required to have improved output characteristics, in particular, improved pulse (intermittent) discharge characteristics, i.e., instantaneous large current characteristics, while maintaining high energy densities as one of their features.

As a kind of lithium primary batteries, there are known graphite fluoride-lithium batteries using graphite fluoride as a positive electrode active material and lithium metal or an alloy thereof as a negative electrode active material. Graphite fluoride-lithium batteries, in which graphite fluoride as a positive electrode active material has an electric capacity density as high as 864 mAh/g, are thermally and chemically stable and thus have excellent long-term storage stability.

Patent Literature 1 discloses the addition of metal or metal oxide fine particles to a positive electrode material of a graphite fluoride-lithium battery. The addition of such fine particles increases the adhesion between the positive electrode material and a current collector, and thus decreases the contact resistance between the positive electrode material and the current collector, resulting in a lithium primary battery having excellent current characteristics at low temperatures. However, since the added fine particles are not involved in the cell reaction but only improves the adhesion between the positive electrode material and the current collector, only limited improvement in the large current characteristics is achieved. Moreover, the addition of a material that is not involved in a cell reaction, like these fine particles, to a positive electrode material leads to a substantial decrease in the energy density of a battery.

Patent Literature 2 discloses a graphite fluoride-lithium battery using a non-aqueous electrolyte solution containing a benzoquinone derivative. A reaction in which the benzoquinone derivative in the non-aqueous electrolyte solution receives electrons proceeds faster than a reaction in which a solid positive electrode active material receives electrons, and the benzoquinone derivative is reduced at a potential close to a positive electrode potential during discharge. Therefore, at the time of large current discharge, the benzoquinone derivative reacts before the positive electrode active material reacts. Such a primary battery can reduce overvoltage at the time of large current discharge, thus preventing a voltage drop.

However, in this primary battery, the benzoquinone derivative is present in the non-aqueous electrolyte solution. Therefore, it is difficult to transform the reduced form of the benzoquinone derivative after discharge into the oxidized form of the benzoquinone derivative before discharge. Thus, in the intermittent use of the primary battery, it is difficult to obtain the effect of preventing a voltage drop repeatedly. Moreover, the benzoquinone derivative in the non-aqueous electrolyte solution does not serve as a positive electrode active material. Since a part of the discharged current is consumed by the reduction reaction of the benzoquinone derivative, the discharge efficiency, i.e., the energy density decreases.

Meanwhile, Patent Literature 3 discloses, as a positive electrode active material for use in an electrical storage device, an organic compound having a plurality of residues of a phenanthrenequinone compound and a linker portion disposed between the residues. The electrical storage device using this positive electrode active material exhibits a high energy density and excellent charge-discharge cycle characteristics.

### CITATION LIST

### Patent Literature

Patent Literature 1 JP 2007-200681 A

Patent Literature 2 WO 2007/032443 A1

Patent Literature 3 WO 2009/118989 A1

### SUMMARY OF INVENTION

### Technical Problem

As described above, attempts to improve the output characteristics of lithium primary batteries have been made, but there is a lack of knowledge about lithium primary batteries capable of exhibiting excellent pulse discharge characteristics repeatedly each time they are used, while maintaining high energy densities as one of their features.

The present invention has been made in view of these circumstances, and it is an object of the present invention to provide a lithium primary battery having improved output characteristics, in particular, improved pulse discharge characteristics, without significantly decreasing the energy density.

### Solution to Problem

The present invention provides a lithium primary battery including a positive electrode including a first active material capable of absorbing a lithium ion and a second active material capable of absorbing and desorbing a lithium ion. The second active material is automatically charged by the first active material while the lithium primary battery is in an open circuit state.

### Advantageous Effects of Invention

In the present invention, the first active material and the second active material are used in the positive electrode. The use of a material capable of absorbing a lithium ion as the first active material makes it possible to maintain a sufficiently high energy density. The use of a material capable of absorbing and desorbing a lithium ion as the second active material makes it possible to obtain excellent pulse discharge characteristics. Furthermore, while this lithium primary battery is in an open circuit state, the reduced form of the second active material is automatically charged by the first active material and transformed into the oxidized form of the second active material. Therefore, according to the lithium primary battery of the present invention, the use of the second active material having superior output characteristics (in particular, superior pulse discharge characteristics) to that of the first active material makes it possible to obtain good pulse discharge characteristics derived from the second active material repeatedly. Since the second active material serves as a positive electrode active material together with the first active material, the problem of a decrease in the energy density is less likely to occur. As described above, the present invention can provide a lithium primary battery having improved output characteristics, in particular, improved pulse discharge characteristics, without a substantial decrease in the energy density.

### BRIEF DESCRIPTION OF DRAWINGS

FIG. 1 is a schematic cross-sectional view showing a coin-type lithium primary battery as an embodiment of the lithium primary battery of the present invention.

FIG. 2 is a graph showing the results of an intermittent discharge test in Example 1.

FIG. 3 is a graph showing the results of a continuous discharge test in Comparative Example 1.

### DESCRIPTION OF EMBODIMENTS

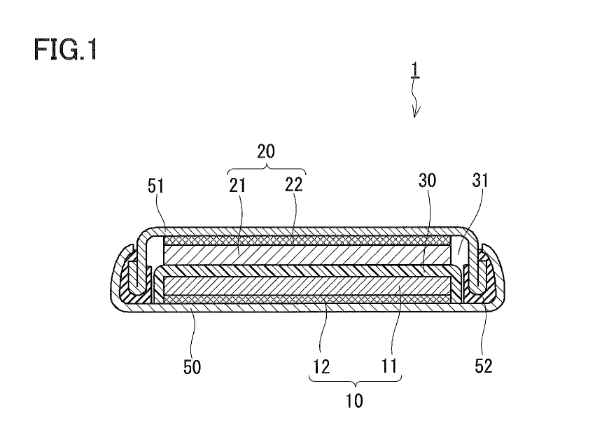

Hereinafter, an embodiment of the lithium primary battery of the present invention is described. FIG. 1 shows a schematic cross-section of a coin-type lithium primary battery 1 as an embodiment of the lithium primary battery of the present invention. This primary battery 1 has a structure including a coin-shaped case 50, a sealing plate 51, and a gasket 52 so as to form an enclosed interior space. In the interior space of the primary battery 1, a positive electrode 10 including a positive electrode active material layer 11 and a positive electrode current collector 12, a negative electrode 20 including a negative electrode active material layer 21 and a negative electrode current collector 22, and a separator 30 are placed. The positive electrode 10 and the negative electrode 20 are arranged so that they face each other with the separator 30 interposed therebetween, with the positive electrode active material layer 11 and the negative electrode active material layer 21 each being in contact with the separator 30. An electrode group consisting of the positive electrode 10, the negative electrode 20, and the separator 30 is impregnated with an electrolyte solution 31.

The positive electrode active material layer 11 includes at least two active materials as positive electrode active materials. One of the at least two active materials is a first active material capable of absorbing lithium ions. The other one of the at least two active materials is a second active material capable of absorbing and desorbing lithium ions. That is, the second active material is a positive electrode active material that can be used also in a lithium secondary battery. The electrolyte solution 31 contains an electrolyte containing a salt of lithium ions and anions.

According to the lithium primary battery of the present embodiment, a high capacity and a high output (excellent pulse discharge characteristics, i.e., excellent repetitive output characteristics) can be achieved for the following two reasons.

The first reason is that two active materials are contained in the positive electrode and they each have their own material properties, in particular, discharge characteristics.

One of the two active materials contained in the positive electrode is a positive electrode active material (first active material) capable of absorbing lithium ions. The first active material is a main active material in the positive electrode of the lithium primary battery. The term “a main active material” refers to an active material whose capacity accounts for 50% or more of the total capacity of the lithium primary battery. As the first active material, a material capable of providing a high voltage of the order of 3 V and a high capacity when lithium ions move from the negative electrode to the positive electrode during discharge, in particular, an inorganic compound can be suitably used. On the other hand, the other one of the two active materials contained in the positive electrode is a positive electrode active material (second active material) capable of absorbing and desorbing lithium ions. Preferably, the second active material is a material having better output characteristics than the first active material. In particular, as the second active material, an organic compound that undergoes a reversible oxidation-reduction reaction with lithium ions is preferred.

It is not known exactly why the use of an inorganic compound capable of absorbing lithium ions as the first active material and the use of an organic compound that undergoes an oxidation-reduction reaction with lithium ions as the second active material makes it possible to achieve both high capacity and repetitive large current characteristics, but the present inventors consider as follows. Since the first active material is present in the form of solid particles, the lithium ion diffusion length and the electron conduction length are relatively long inside the particles, and these lengths cause the resistance to increase, resulting in a slow reaction with lithium ions. On the other hand, since the second active material, that is, an organic compound, can be dispersed or dissolved in a specific organic solvent, they can be present in the molecularly dispersed form. Therefore, the lithium ion diffusion length in the active material is shorter, resulting in a faster reaction therewith. As just described, the reaction of the organic compound as the second active material to absorb lithium ions proceeds faster than the reaction of the first active material to absorb lithium ions. The faster reaction with lithium ions means better large current characteristics.

In the case where a large current discharge is performed using an active material that reacts slowly with lithium ions, the voltage usually drops significantly from the open circuit voltage due to a high reaction resistance. Then, as a reaction path is formed between the active material and lithium ions with time, the voltage rises slowly to a level high enough to discharge. When a discharge current value is low, a voltage drop is negligibly small. When a discharge current value is high (when a large current discharge is performed), the voltage drops to or below the lower limit operating voltage of a device equipped with the battery, which may render the device inoperable. When the reaction between the active material and lithium ions proceeds slowly, the range of available discharge current values may be narrowed.

In contrast, in the case where an active material that reacts rapidly with lithium ions is used, the voltage drops only slightly when a discharge current is drawn. Thus, a discharge with a large current can be performed. Therefore, even if a discharge is performed with such a large current as to make it difficult to draw a current from the first active material, the use of the first active material in combination with the second active material capable of reacting rapidly with lithium ions makes it possible to draw a current from the second active material, and thus the range of discharge current values available for the battery can be widened.

As described above, the second active material, which is an organic compound that undergoes a reversible oxidation-reduction reaction with lithium ions, can contribute to a high output, in particular, excellent pulse discharge characteristics. Furthermore, since the second active material itself has an oxidation-reduction capacity, its energy density does not decrease significantly even if it is used together with the first active material. That is, the second active material can contribute to both a high capacity and a high output.

The second reason is a synergistic effect of the combined use of the two active materials. This is specifically explained based on the relationship among the open circuit potential of the first active material at 0% depth of discharge relative to a lithium electrode, the average discharge potential of the first active material, and the open circuit potential of the second active material at 0% depth of discharge relative to the lithium electrode. The phrase “an open circuit potential of an active material at 0% depth of discharge relative to a lithium electrode” refers to the open circuit voltage at 0% depth of discharge of a lithium primary battery including a lithium electrode as a negative electrode and a positive electrode containing only this active material as a positive electrode active material. Hereinafter, an open circuit potential of an active material at 0% depth of discharge relative to a lithium electrode may be referred to simply as the “open circuit potential of the active material”. Furthermore, an “average discharge potential of an active material” refers to the discharge potential of the active material at 50% depth of discharge relative to a lithium electrode.

First, it is preferable that the open circuit potential of the second active material be lower than that of the first active material. Preferably, the open circuit potential of the second active material is lower, for example, by 0.05 V to 1.0 V, than that of the first active material.

In this case, when a large current is drawn from the positive electrode (a large output is required), the current is first drawn from a compound with a higher potential, i.e., the first active material. Since the discharge reaction of the first active material proceeds relatively slowly, if a large current is first drawn from the first active material, the resistance increases and the voltage drops. However, since the discharge reaction of the second active material proceeds relatively faster than that of the first active material, the second active material can start a discharge reaction when the voltage drops to its discharge start potential. As the discharge reaction of the second active material proceeds, a reaction path is formed between the first active material and lithium ions. As a result, the first active material can start discharging. For example, if the first active material is graphite fluoride, a highly resistive coating film is formed on the surface of the graphite fluoride at an early stage of the discharge reaction, and thus the voltage drops and the discharge reaction of the second active material starts. As the discharge reaction of the second active material proceeds, the graphite fluoride forms a less resistive coating film on its surface and then can start a discharge reaction together with the second active material. In this way, the first active material having a high capacity and the second active material that can contribute to a large current discharge, i.e., the second active material having a high output can complement each other for the discharge.

Furthermore, it is preferable that the open circuit potential of the second active material be lower than that of the first active material and higher than the average discharge potential of the first active material.

In this case, the relationship that the charge potential of the second active material lies between the positive electrode potential and the discharge potential of the first active material when the discharge of the battery is interrupted can be obtained easily in a wide range of depths of discharge. If this relationship is satisfied in the battery in an open circuit state, the second active material in the discharged state is automatically charged by the first active material. In other words, the second active material which has been transformed into the reduced form by discharge is oxidized by the undischarged first active material and transformed into the oxidized form of the second active material, i.e., the second active material in the charged state. Even if all the second active material in the positive electrode is discharged, it is automatically charged by the first active material as long as the charge potential of the second active material lies between the positive electrode potential and the discharge potential of the first active material. The second active material thus automatically charged can contribute to a large current discharge again.

Here, the region with about 5 to 90% depth of discharge in the battery corresponds to a discharge plateau in the discharge curve of the battery, and in this region, a current can be drawn stably through a normal discharge reaction. In this region, the first active material has a capacity large enough to charge the second active material. From these viewpoints, there is no problem in the practical use of the battery if it satisfies, for example, the relationship [positive electrode potential]>[charge potential of second active material]>[discharge potential of first active material], with respect to lithium, in the range of 5% to 90% depth of discharge. It should be noted that in this description, a “positive electrode potential” refers to the positive electrode potential in an open circuit state. The positive electrode potential is defined as the potential of a positive electrode relative to that of a negative electrode, that is, as the battery voltage. The open circuit state refers to the state in which the electrical continuity between a battery and a load is interrupted, that is, the state in which the battery is not connected to the load (in an unloaded state). The state in which a very weak current such as a leakage current flowing through a semiconductor switch flows can be regarded as an unloaded state. As just described, since the second active material in the discharged state is automatically charged by the first active material, a discharge with a large current (large current pulse discharge) can be repeated without adding a large amount of second active material to the positive electrode.

For the above-mentioned two reasons, the present invention can provide a lithium primary battery having a high capacity and a high output (excellent pulse discharge characteristics).

Hereinafter, constituent materials that can be used for the lithium primary battery of the present embodiment are described.

As the first active material, a positive electrode active material for use in a lithium primary battery having a high open circuit potential and a high capacity can be used. From the viewpoint of the energy density, it is preferable that the first active material be a positive electrode active material that can be discharged at potentials ranging from about 1.5 to 4 V with respect to lithium. Specific examples of the first active material include graphite fluoride, manganese dioxide, and thionyl chloride. Among them, it is preferable to use graphite fluoride as the first active material. The use of graphite fluoride as the first active material makes it possible to obtain a positive electrode having a high capacity and good discharge characteristics because of its advantages such as a large discharge capacity and a stable discharge behavior. Graphite fluoride can be discharged at about 2.0 to 4.0 V with respect to lithium, although the potential varies depending on the conditions such as the type of electrolyte solution, the test current value, and the temperature. The open circuit potential of graphite fluoride is about 3.0 to 3.8 V with respect to lithium. The average discharge potential of graphite fluoride is about 2.5 to 3.2 V with respect to lithium. Manganese dioxide can be discharged at about 2.0 to 3.5 V with respect to lithium, and its average discharge potential is about 2.7 V. Thionyl chloride can be discharged at about 2.0 to 4.0 V with respect to lithium, and its average discharge potential is about 3.6 V.

As the second active material, an organic compound that undergoes a reversible oxidation-reduction reaction with lithium ions can be used. As described above, the average discharge potential of the first active material is preferably about 1.5 to 4 V with respect to lithium. Therefore, it is particularly preferable that the second active material be a material that can absorb and desorb lithium ions at potentials ranging from about 2 to 4 V with respect to lithium.

Generally, the lower limit operating voltage of a device equipped with a lithium primary battery is about 2.0 V. Therefore, the lower limit operating voltage of the lithium primary battery of the present embodiment also is set to 2.0 V or higher. In the present embodiment, the discharge potential of the first active material is approximately 2.5 to 3.5 V. The average discharge potential of the lithium primary battery of the present embodiment is approximately 2.3 to 3.0 V. Therefore, it is desirable that the average discharge potential of the second active material be 2.0 V or more relative to the negative electrode of the lithium primary battery. It is preferable that the average discharge potential of the second active material lie between the average discharge potential of the first active material and the open circuit potential of the first active material at 0% depth of discharge (DOD).

The use of an organic compound as the second active material makes it easier to obtain a lithium primary battery having a high capacity and a repetitive high output (excellent pulse discharge characteristics) for the following four reasons.

The first reason is that the molecule of an organic compound can be designed more easily than that of a metal or a metal oxide and thus its oxidation-reduction potential can be controlled by a molecular skeleton and a substituent introduced into the molecular skeleton. For example, when an electron accepting substituent is introduced into the molecular skeleton, the potential of the discharge reaction further increases. When an electron donating substituent is introduced into the molecular skeleton, the potential of the discharge reaction further decreases. As just described, in the case where the second active material is an organic compound, the oxidation-reduction potential and the open circuit potential thereof can be controlled in accordance with the discharge characteristics of the first active material. Specifically, the organic compound can be designed so that it has an oxidation-reduction potential in a potential range lower than the open circuit potential of the first active material and higher than the average discharge potential of the first active material. Furthermore, the organic compound can be designed so that after it is discharged, it is automatically charged by the first active material. Therefore, the use of an organic compound as the second active material can offer a wider choice of first active materials.

The second reason is that the use of an organic compound as the second active material makes it easier to maintain the reliability of the battery during long-term use, etc. The use of an oxide of a metal such as vanadium as the second active material may cause the elution of the metal from the second active material during long-term use, etc., resulting in a decrease in the reliability of the battery. Particularly in the primary battery which is constantly present in a charged state, the positive electrode active material is constantly exposed to the charged, high potential state. Therefore, there is a concern that the metal may be eluted, thus adversely affecting the reliability. In the primary battery of the present embodiment, the second active material is constantly charged by the first active material and thus is constantly present in the charged state. Therefore, it is desirable to use, as the second active material, an organic compound that is free from elution of metal. For example, graphite fluoride, which can be used as the first active material, not only contains no metal ions and has a high capacity but also has high long-term reliability. A combined use of this graphite fluoride and a material containing metal ions as the second active material may cause a decrease in the long-term reliability as one of the features of graphite fluoride. When an organic compound is used as the second active material, such a problem is less likely to occur.

The third reason is that the use of an organic compound as the second active material makes it possible to easily adjust the size of the particles of the second active material and to employ various processes to produce the positive electrode.

A positive electrode for a common lithium primary battery is produced from a mixture of particles of an active material, such as a metal or a metal oxide, and a conductive agent and others. The active material particles have a particle size of several microns to tens of microns. In this positive electrode, electron conduction and ion conduction cause a discharge reaction in and between the active material particles. The rate of electron conduction and the rate of ion conduction in and between the particles are not so high. As a result, it is difficult to obtain a sufficiently high discharge reaction rate and large current characteristics. As described above, the use of the particles of the second active material having a smaller particle size than that of the first active material allows the discharge reaction of the second active material to proceed faster than that of the first active material, thus achieving high output characteristics. When the second active material is an organic compound, it is easy to adjust the size thereof at the molecular level. Therefore, the size of the second active material can be adjusted according to the particle size of the first active material so that the second active material has a smaller size than that of the first active material. Furthermore, an organic compound, even a polymer compound, can be dissolved in a specific solvent by the molecular design of the compound and the selection of the solvent. Therefore, various processes can be employed to produce the positive electrode containing an organic active material as the second active material.

For example, a thin film of the second active material can be formed in the positive electrode by employing the following process. A solution containing an organic compound dissolved therein is prepared, and the particles of the first active material are dispersed in this solution to obtain a paste. The solvent contained in the paste is removed so as to coat the surface of the first active material particles with a thin film of the second active material.

Another process can also be employed. First, an organic compound as the second active material, a conductive agent, and a solvent capable of dissolving the second active material are mixed to prepare a solution. Preferably, the organic compound as the second active material is a polymer. Next, the solvent is removed from the resulting solution so as to form composite particles of the conductive agent and the second active material. In the composite particles, the second active material is present in the form of a thin film that covers the surface of the conductive agent. As the conductive agent, for example, carbon particles can be used. The shape of the particles is not particularly limited. Any conductive agent having a known shape, such as a spherical or fibrous shape, can be used. Next, the first active material particles and the composite particles are mixed to obtain a mixed material of the first active material and the second active material. Additives such as an additional conductive agent and a binder may be added to the mixed material as needed. A compact of the resulting mixed material is placed on a positive electrode current collector to form a positive electrode active material layer. The positive electrode thus obtained, a negative electrode, and a separator are assembled. Thus, a lithium primary battery is obtained.

In the case where the thin film of the organic compound second active material is formed in the positive electrode, the high output characteristics can be further enhanced. Even if the reaction rate of the organic compound second active material per molecule is high enough, if its reaction rate is low in the positive electrode, it is difficult to obtain excellent high output characteristics. However, since the second active material has a thin film shape in the positive electrode, the reaction rate of the second active material can be increased close to its reaction rate per molecule, and thus a rapid oxidation-reduction reaction can be achieved. Furthermore, since the surface of the first active material and the conductive agent is coated with the thin film of the second active material, the area of contact between the first active material and the second active material is increased, and thus the second active material can be automatically charged by the first active material with high efficiency. As a process for forming a thin film of the second active material in the positive electrode, various processes can be employed in addition to the techniques mentioned above. For example, a technique of immersing the positive electrode made of the first active material particles into a solution containing the second active material dissolved therein can be employed.

The fourth reason is that organic compounds have lower specific gravities than those of metals, metal oxides, etc. Therefore, with the use of an organic compound as the second active material, a lightweight lithium primary battery can be obtained.

Examples of the organic compound that can be used as the second active material include an organic compound having two or more groups represented by C═X in a molecule (where “C” denotes carbon). The group represented by C═X is a group that is involved in absorption and desorption of lithium into and from the second active material. X in the group represented by C═X is typically an oxygen atom, a sulfur atom, or C(CN)₂. That is, examples of the organic compound that can be used as the second active material include an organic compound having two or more ketone groups in a molecule, an organic compound having two or more thioketone groups in a molecule, and an organic compound having two or more cyano groups in a molecule. Furthermore, an organic compound having two or more sulfide groups in a molecule also can be suitably used as the second active material.

In particular, an organic compound having any of the above-mentioned groups on the aromatic skeleton is suitably used. The organic compound having two or more ketone groups, the organic compound having two or more thioketone groups, and the organic compound having two or more cyano groups have, for example, a structure represented by Formula (1) below. In Formula (1), X is an oxygen atom, a sulfur atom, or C(CN)₂. R²¹ to R²⁴ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R²¹ to R²⁴ may have, as a substituent, a group having at least one atom selected from the group consisting of a fluorine atom, a nitrogen atom, an oxygen atom, a sulfur atom, and a silicon atom. R²¹ and R²² may be bonded to each other to form a ring. R²³ and R²⁴ may be bonded to each other to form a ring. Examples of the compound having two or more sulfide groups in a molecule include organic disulfide compounds.

The reaction mechanism of a thioketone group is the same as that of quinone. The reaction mechanism of C(CN)₂ is the same as that of quinone, except that four lithium ions are involved in the reaction. The reaction mechanism of disulfide is represented by R—S—S—R+2Li→2R—SLi.

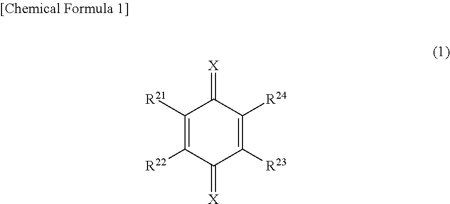

It is preferable that the organic compound used as the second active material be a compound (hereinafter referred simply as a “cyclic conjugated ketone”) having a cyclic skeleton having carbon atoms at least two of which each form a ketone group, the cyclic skeleton forming a conjugated system together with the at least two ketone groups. Typical examples of the cyclic conjugated ketone include a paraquinone compound and an orthoquinone compound. Since the cyclic conjugated ketone can undergo a reversible oxidation-reduction reaction and a two-electron reaction, it can be used as the second active material having a high energy density. This is described below.

A ketone group is a negatively charged electrode reaction site and can undergo an oxidation-reduction reaction with a positively charged migrating carrier. In the reduction reaction of the ketone group, if the migrating carrier is a lithium ion, a change in the charge density (negative charge) of the ketone group and a change in the charge density (positive charge) of the lithium ion form a bond between the oxygen atom of the ketone group and the lithium atom. For example, an oxidation-reduction reaction between a paraquinone compound having two ketone groups in the para position and lithium ions is represented as a two-step reaction, as shown in Formulae (2A) and (2B) below.

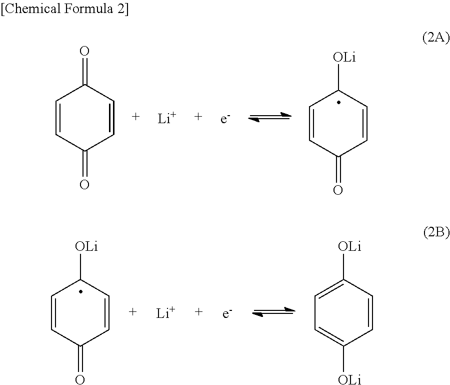

For a reversible oxidation-reduction reaction between the ketone groups and the lithium ions, the bonds formed between the ketone groups and the lithium ions need to be dissociable by an electrochemical reaction. In Formulae (2A) and (2B), the charge distribution in the paraquinone compound that has reacted with the lithium ions is localized. In this case, the bonds formed between the ketone groups and the lithium ions are relatively hard to dissociate. Therefore, in most cases, the difference between two reaction potentials of the paraquinone compound is larger than that between two reaction potentials of the orthoquinone compound. The “two reaction potentials” refer to the reduction potentials at which the two ketone groups of the quinone compound undergo independent reactions. In addition, the paraquinone compound is less reversible in a reaction with lithium ions.

In contrast, for example, a triketone compound in which oxygen atoms are bonded to three adjacent carbon atoms on a one-to-one basis can react with lithium ions, each of which is interposed between two adjacent ketone groups, as shown in Formulae (3A) and (3B) below. In this case, since the negative charge of the ketone groups is delocalized, the bond strength between the ketone groups and the lithium ions is reduced, resulting in an increase in the reversibility of the oxidation-reduction reaction therebetween.

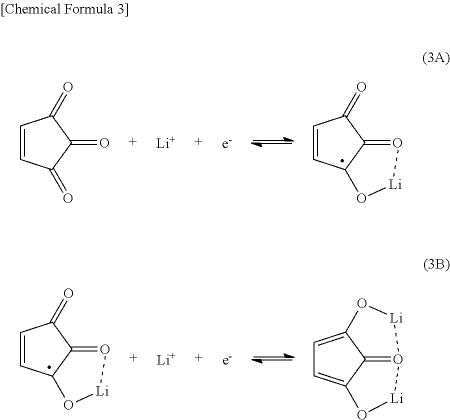

As described above, a cyclic conjugated ketone having two ketone groups in the ortho or vicinal position (such as an orthoquinone compound or a triketone compound) can enhance the reversibility of the oxidation-reduction reaction, compared to a compound having two unadjacent ketone groups (such as a paraquinone compound). In addition, the difference between the potentials of the reduction reactions in which two electrons are respectively involved is reduced in most cases.

An organic compound having a larger molecular weight has a lower solubility in an organic solvent. Therefore, the organic compound used as the second active material is preferably a polymer (including a concept of an oligomer). This makes it possible to suppress the dissolution of the second active material in a non-aqueous electrolyte solution and to suppress the deterioration of the repetitive output characteristics of the lithium primary battery. Thus, it is ensured that the second material can be present in solid form in the positive electrode.

Preferably, the polymer has a high molecular weight. Specifically, it is preferable that the polymer have four or more cyclic conjugated ketone skeletons in a molecule. Therefore, the polymerization degree of the polymer is preferably 4 or more. Thereby, the second active material that is less likely to dissolve in a non-aqueous electrolyte solution can be obtained. The polymerization degree of the polymer is more preferably 10 or more, and further preferably 20 or more. The cyclic conjugated ketone skeleton refers to a cyclic skeleton having carbon atoms at least two of which each form a ketone group, the cyclic skeleton forming a conjugated system together with the at least two ketone groups. It is desirable that the two carbon atoms each forming a ketone group be adjacent to each other in the cyclic skeleton.

The cyclic conjugated ketone is, for example, a polymer having a 9,10-phenanthrenequinone skeleton shown in Formula (4) below in the repeating unit. In Formula (4), R¹ to R⁸ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R¹ to R⁸ may have, as a substituent, a group having at least one atom selected from the group consisting of a fluorine atom, a nitrogen atom, an oxygen atom, a sulfur atom, and a silicon atom.

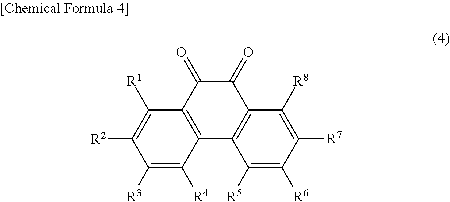

The cyclic conjugated ketone may have a structure shown in Formula (5) or (6) below. In Formula (5), R²⁵ to R²⁸ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R²⁵ to R²⁸ may have, as a substituent, a group having at least one atom selected from the group consisting of a fluorine atom, a nitrogen atom, an oxygen atom, a sulfur atom, and a silicon atom.

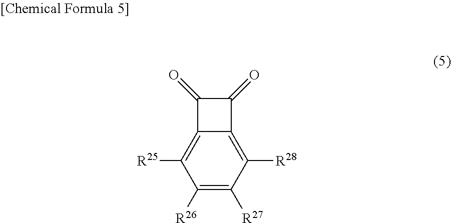

In Formula (6), R³¹ to R³⁶ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R³¹ to R³⁶ may have, as a substituent, a group having at least one atom selected from the group consisting of a fluorine atom, a nitrogen atom, an oxygen atom, a sulfur atom, and a silicon atom.

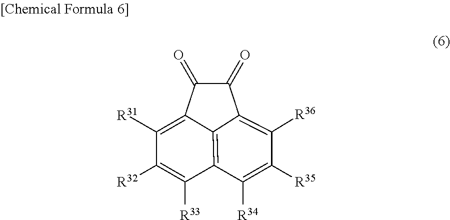

The cyclic conjugated ketone may be a polymer having a triketone skeleton with three ketone portions in the repeating unit. The triketone skeleton is represented by Formula (7) below, for example. In Formula (7), R⁹ and R¹⁰ are each independently a hydrogen atom, a fluorine atom, an unsaturated aliphatic group, or a saturated aliphatic group. The unsaturated aliphatic group and the saturated aliphatic group may each have a halogen atom, a nitrogen atom, an oxygen atom, a sulfur atom, or a silicon atom. R⁹ and R¹⁰ may be bonded to each other to form a ring. At least one substituent selected from the group consisting of a fluorine atom, a cyano group, an alkyl group having 1 to 4 carbon atoms, an alkenyl group having 2 to 4 carbon atoms, a cycloalkyl group having 3 to 6 carbon atoms, a cycloalkenyl group having 3 to 6 carbon atoms, an aryl group, and an aralkyl group may be bonded to the ring formed by the bond of R⁹ and R¹⁰. The substituent may have at least one atom selected from the group consisting of a fluorine atom, a nitrogen atom, an oxygen atom, a sulfur atom, and a silicon atom.

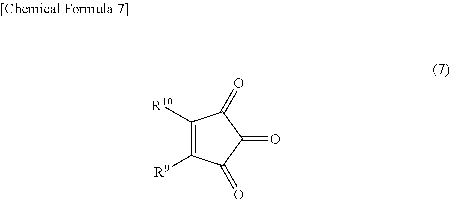

The cyclic conjugated ketone may be a polymer having a tetraketone skeleton with four ketone portions in the repeating unit. The tetraketone skeleton is represented by Formula (8) below, for example. In Formula (8), R¹¹ to R¹⁶ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R¹¹ to R¹⁶ may have, as a substituent, a group having at least one atom selected from the group consisting of a fluorine atom, a nitrogen atom, an oxygen atom, a sulfur atom, and a silicon atom. The tetraketone skeleton represented by Formula (8) is specifically a pyrene-4,5,9,10-tetraone skeleton.

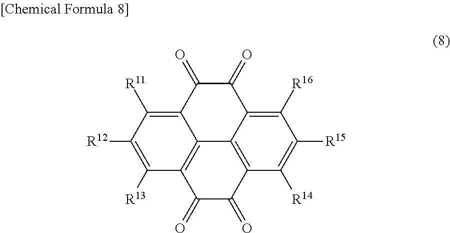

The cyclic conjugated ketone may have a structure shown in Formula (9) or (10) below. In Formula (9), R³⁷ and R³⁸ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R³⁷ and R³⁸ may have, as a substituent, a group having at least one atom selected from the group consisting of a fluorine atom, a nitrogen atom, an oxygen atom, a sulfur atom, and a silicon atom.

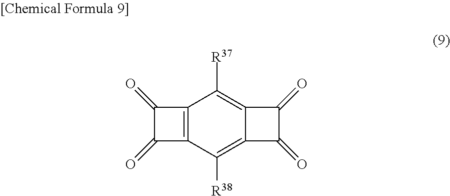

In Formula (10), R⁴¹ to R⁴⁴ are each independently a hydrogen atom, a fluorine atom, a cyano group, an alkyl group having 1 to 4 carbon atoms, an alkenyl group having 2 to 4 carbon atoms, an aryl group, or an aralkyl group. Each of the groups denoted as R⁴¹ to R⁴⁴ may have, as a substituent, a substituent having at least one atom selected from the group consisting of a fluorine atom, a nitrogen atom, an oxygen atom, a sulfur atom, and a silicon atom.

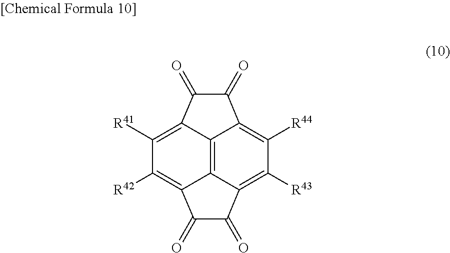

The cyclic conjugated ketone is not particularly limited. Preferably, the cyclic conjugated ketone includes at least one cyclic conjugated ketone skeleton selected from the group consisting of a phenanthrenequinone skeleton, a triketone skeleton, and a tetraketone skeleton. More preferably, the cyclic conjugated ketone is, among them, an organic compound having a phenanthrenequinone skeleton or a tetraketone skeleton (a phenanthrenequinone compound or a tetraketone compound). Furthermore, from the viewpoint of the above-mentioned reversibility of the oxidation-reduction reaction, two ketone groups in each of these skeletons are preferably in the ortho position to each other.

It is preferable that the cyclic conjugated ketone be a polymer of directly bonded cyclic conjugated ketone skeletons or an alternating copolymer of cyclic conjugated ketone skeletons and linker portions each having no ketone portion. Formula (11) shows an example of the polymer of directly bonded phenanthrenequinone skeletons. Formula (12) shows an example of the alternating copolymer of phenanthrenequinone skeletons and linker portions L each having no ketone portion. The linker portion L is, for example, a divalent residue or a trivalent residue of an aromatic compound having no ketone group. The linker portion may have at least one of a sulfur atom and a nitrogen atom, and may have at least one substituent selected from the group consisting of a fluorine atom, a saturated aliphatic group, and an unsaturated aliphatic group. The cyclic conjugated ketone having linker portions can undergo a smooth two-step oxidation-reduction reaction derived from the cyclic conjugated ketone skeletons. The linker portion L is typically a phenylene group.

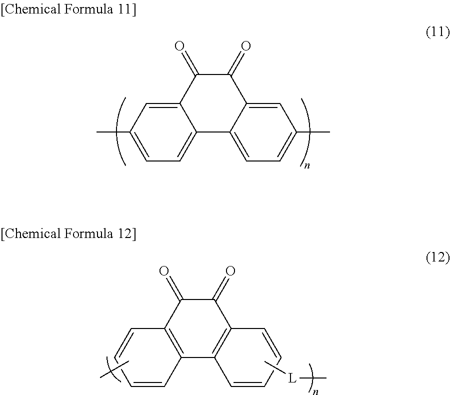

As described with reference to Formulae (11) and (12), the structures shown in Formulae (1) and (4) to (10) may each be contained in the main chain of the polymer. Furthermore, the structures shown in Formulae (1) and (4) to (10) may each be contained in the side chain of the polymer. For example, in Formula (1), any one of R²¹ to R²⁴ may form a bond with one end of a polymer composed mainly of carbon. The “polymer composed mainly of carbon” refers to a polymer having the highest content of carbon in atomic percent. Likewise, any one of R¹ to R⁸ in Formula (4), R²⁵ to R²⁸ in Formula (5), R³¹ to R³⁶ in Formula (6), R⁹ and R¹⁰ in Formula (7), R¹¹ to R¹⁶ in Formula (8), R³⁷ and R³⁸ in Formula (9), and R⁴¹ to R⁴⁴ in Formula (10) may form a bond with one end of a polymer composed mainly of carbon. Formulae (13) and (14) below show examples of the polymer containing an oxidation-reduction site in its side chain.

In Formula (13), R¹¹ and R¹³ to R¹⁶ are as described with reference to Formula (8). R¹⁷ is an alkylene chain having 1 to 4 carbon atoms, an alkenylene chain having 2 to 4 carbon atoms, an arylene chain, an ester bond, an amide bond, or an ether bond, and may have a substituent. R¹⁸ is a methyl group or an ethyl group. n is an integer of 2 or more.

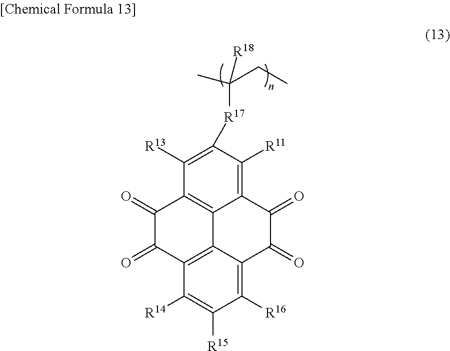

The polymer of Formula (14) is composed of repeating units each having an oxidation-reduction site (a tetraketone skeleton in this case) and repeating units each having no oxidation-reduction site. These two types of repeating units are bonded to each other at symbols *. In Formula (14), R¹¹ and R¹³ to R¹⁶ are as described with reference to Formula (8). m and n each are an integer of 2 or more. The ratio (m:n) of the repeating units each having an oxidation-reduction site and the repeating units each having no oxidation-reduction site is, for example, in the range of 100:0 to 20:80. The polymer composed of the repeating units each having an oxidation-reduction site and the repeating units each having no oxidation-reduction site may be any one of an alternating copolymer, a random copolymer, and a block copolymer.

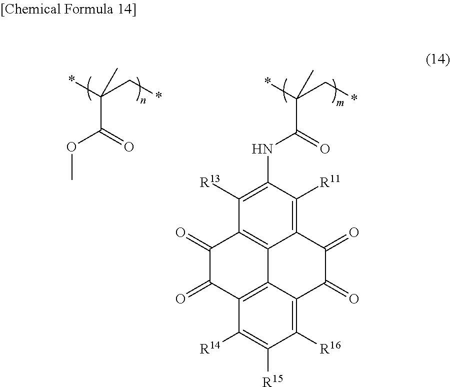

An organic compound that can be used as the second active material is not limited to a polymer. That is, monomers, dimers, trimers, etc. having the structures shown in Formulae (1) and (4) to (10) may be usable as the second active material.

For example, in the case where a conductive polymer compound like polyaniline is used as the second active material, it can react with only about 0.25 electrons at most per aniline skeleton due to strong intermolecular repulsion, which results in a decrease in the energy density. Since there is little intermolecular repulsion in an oligomer or a polymer having a cyclic conjugated ketone skeleton, such an oligomer or polymer can react with one electron per ketone group in one cyclic conjugated ketone skeleton. This means that the oligomer or the polymer having two ketone groups in the unit skeleton can react with two electrons and the oligomer or the polymer having four ketone groups therein can react with four electrons.

The second active material may be either in the charged state or in the discharged state (reduced and lithiated state) when assembly of the lithium primary battery is completed. The phrase “when assembly of the battery is completed” refers to the time of completion of the following steps: preparing a positive electrode and a negative electrode respectively and placing them in a battery case so that they face each other with a separator interposed therebetween; then pouring an electrolyte solution to impregnate the electrodes with the electrolyte solution; and sealing the battery case. However, from the viewpoint of energy density, it is preferable that the second active material be in the charged state when the assembly of the battery is completed. In other words, it is preferable that substantially all the first active material be in the charged state at 0% depth of discharge of the battery. In the case where the second active material is in the discharged state when the assembly of the batter is completed, the second active material in the discharged state is automatically charged by the first active material soon after the assembly of the battery. Since the first active material is discharged by the amount of charge of the second active material, the capacity of the battery decreases by the amount of discharge of the first active material. In the case where the second active material is in the charged state when the assembly of the battery is completed, both the capacity of the first active material and the capacity of the second active material can be used for discharge. As a result, a higher energy density can be achieved.

The content of the second active material in the positive electrode is, for example, 0.1 to 50%, and preferably 1 to 20%, in terms of the design capacity of the second active material relative to the total design capacity of the positive electrode of the lithium primary battery. This makes it possible to construct a lithium primary battery that can achieve both a high capacity derived from the first active material and a high output derived from the second active material.

Next, other components of the lithium primary battery 1 are described.

The positive electrode active material layer 11 may contain a conductive agent for enhancing the electron conductivity in the electrode and/or a binder for maintaining the shape of the positive electrode active material layer 11, if necessary, in addition to the first active material and the second active material. Examples of the conductive agent include carbon materials such as carbon black, graphite and carbon fibers, metal fibers, metal powders, conductive whiskers, and conductive metal oxides. Mixtures thereof also may be used. The binder may be either a thermoplastic resin or a thermosetting resin. Examples of the binder include: polyolefin resins typified by polyethylene and polypropylene; fluorine resins typified by polytetrafluoroethylene (PTFE), polyvinylidene fluoride (PVDF) and hexafluoropropylene (HFP), and copolymeric resins thereof; styrene-butadiene rubbers; and polyacrylic acids and copolymeric resins thereof. Mixtures thereof also may be used.

For the positive electrode current collector 12, materials known as positive electrode current collector materials for lithium primary batteries can be used. The positive electrode current collector 12 is, for example, a metal foil or a metal mesh made of a metal such as aluminum, carbon, or stainless steel. In the case where a metal foil or a metal mesh is used as the positive electrode current collector 12, good electrical contact between the positive electrode current collector 12 and the case 50 can be maintained by welding them together. In the case where the positive electrode active material layer 11 has a self-standing shape such as a pellet or a film, the positive electrode active material layer 11 may be configured to directly contact the case 50 without using the positive electrode current collector 12.

The negative electrode active material layer 21 contains a negative electrode active material. For the negative electrode active material, known negative electrode active materials capable of desorbing lithium ions are used. Examples of the negative electrode active material include lithium-absorbed graphite materials typified by natural graphite and artificial graphite; lithium-absorbed amorphous carbon materials; lithium metal; lithium-aluminum alloys; lithium-containing composite nitrides; lithium-containing titanium oxides; lithium-absorbed silicon, alloys containing silicon, and silicon oxides; and lithium-absorbed tin, alloys containing tin, and tin oxides. Mixtures thereof also may be used. For the negative electrode current collector 22, materials known as negative electrode current collector materials for lithium primary batteries can be used. The negative electrode current collector 22 is, for example, a metal foil or mesh made of a metal such as copper, nickel or stainless steel. In the case where the negative electrode active material layer 21 has a self-standing shape such as a pellet or a film, the negative electrode active material layer 21 may be configured to directly contact the sealing plate 51 without using the negative electrode current collector 22.

The negative electrode active material layer 21 may contain a conductive agent and/or a binder, if necessary, in addition to the negative electrode active material. As the conductive agent and the binder, the same materials as those of the conductive agents and binders that can be used for the positive electrode active material layer 11 can be used.

The separator 30 is a layer made of a resin having no electron conductivity or a nonwoven fabric. The separator 30 is also a microporous membrane having high ion permeability, as well as sufficient mechanical strength and electrical insulation. Preferably, the separator 30 is made of a polyolefin resin such as polypropylene, polyethylene, or a combination thereof, because the polyolefin resin is highly resistant to organic solvents and highly hydrophobic. An ion-conductive resin layer that is swollen with an electrolyte solution to serve as a gel electrolyte may be provided instead of the separator 30.

The electrolyte solution 31 contains an electrolyte containing a salt of a lithium ion and an anion. The salt of a lithium ion and an anion is not particularly limited as long as it can be used in a lithium battery. Examples of the salt include a salt of a lithium ion and any one of the following types of anions. Examples of the anions include a halide anion, a perchlorate anion, a trifluoromethanesulfonate anion, a tetrafluoroborate anion (BF₄−), a hexafluorophosphate anion (PF₆−), a bis(trifluoromethanesulfonyl)imide anion, and a bis(perfluoroethylsulfonyl)imide anion. Two or more types of these anions may be used in combination for salts of lithium ions and anions.

The electrolyte may contain a solid electrolyte in addition to the salt of a lithium ion and an anion. Examples of the solid electrolyte include Li₂S—SiS₂, Li₂S—B₂S₅, Li₂S—P₂S₅—GeS₂, sodium/alumina (Al₂O₃), amorphous polyether or polyether with a low phase transition temperature (Tg), amorphous vinylidene fluoride-hexafluoropropylene copolymer, and heterogeneous polymer blend polyethylene oxide.

In the case where the electrolyte is a liquid, the electrolyte itself may be used as the electrolyte solution 31, or the electrolyte may be dissolved in a solvent to use the solution as the electrolyte solution 31. In the case where the electrolyte is a solid, it can be dissolved in a solvent to obtain the electrolyte solution 31.

As the solvent for dissolving the electrolyte, known non-aqueous solvents that can be used for lithium primary batteries using non-aqueous electrolyte solutions can be used. As a specific non-aqueous solvent, a solvent containing a cyclic carbonate ester or a cyclic ester can be suitably used because cyclic carbonate esters and cyclic esters have very high dielectric constants. Examples of cyclic carbonate esters include ethylene carbonate and propylene carbonate, and among them, propylene carbonate is preferred because propylene carbonate has a freezing point of −49° C., which is lower than that of ethylene carbonate, thus allowing the lithium primary battery to operate even at low temperatures. Examples of cyclic esters include γ-butyrolactone.

A non-aqueous solvent containing any of these solvents as a component of the non-aqueous solvent can have a very high dielectric constant as a whole in the electrolyte solution 31. As the non-aqueous solvent, only one of these solvents may be used, or two or more of these may be mixed for use. Examples of the component of the non-aqueous solvent include chain carbonate esters, chain esters, and cyclic or chain ethers, in addition to the components listed above. Specific examples of the component include dimethyl carbonate, diethyl carbonate, methyl ethyl carbonate, dioxolane, and sulfolane.

The above-described embodiment can provide a lithium primary battery that can achieve both a high capacity and a high output (excellent pulse discharge characteristic).

Conventionally, structural approaches, such as optimization of the electrode thickness and length, have been taken to increase the output in cylindrical batteries and prismatic batteries. In contrast, the present invention takes a material approach to increase the output. This means that the present invention is the most effective approach to increase the output in the case where the outer case of a battery has a simple structure and its shape cannot be changed, for example, in the case of a coin-type battery.

### EXAMPLES

Hereinafter, examples of the present invention are described. The present invention is not limited to these examples.

The open circuit potential and the average discharge potential of each of active materials used in the examples were measured in the following manner. First, a coin-type lithium primary battery shown in FIG. 1 was produced using a positive electrode containing only one active material in an oxidized state (charged state) as a positive electrode active material and a negative electrode made of lithium metal. After the lithium primary battery was thus produced, its voltage was measured with no current load. Thus, the open circuit potential of this active material was obtained. The discharge characteristics of a lithium primary battery produced in the same manner as above were measured. The potential at 50% depth of discharge in the obtained discharge curve was taken as an average discharge potential of the active material.

### Example 1

In Example 1, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and a polymer X shown in Formula (15), i.e., a quinone compound, was used as the second active material. The synthesis method of the polymer X is described in detail in Patent Literature 3, etc. The molecular weight of the polymer X used was 9783 (a value relative to polystyrene standards) in terms of weight-average molecular weight, and the polymerization degree of the polymer X was about 30. The open circuit potential of graphite fluoride (CF)ₙ at 0% DOD was 3.15 V, and the average discharge potential thereof was 2.55 V. The open circuit potential of the polymer X at 0% DOD was 3.05 V.

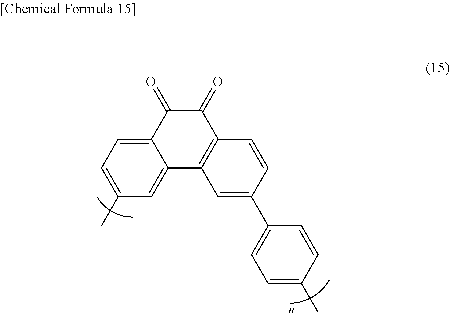

[Preparation of Positive Electrode]

15 mg of the polymer X represented by Formula (15), 15 mg of graphite fluoride (CF)ₙ, and 80 mg of acetylene black as a conductive agent were weighed, and put into a mortar and mixed. Furthermore, 20 mg of polytetrafluoroethylene as a binder was added and mixed in the mortar. The mixture thus obtained was press-bonded onto a stainless steel mesh (30 mesh, manufactured by the Nilaco Corporation) as a current collector by means of a roller, vacuum-dried, and stamped into a disk shape with a diameter of 16 mm. Thus, a positive electrode was prepared. The weights of graphite fluoride and the polymer X as the active materials contained in this positive electrode were 1.5 mg and 1.5 mg, respectively.

[Production of Lithium Primary Battery]

The positive electrode thus prepared was used as a positive electrode, and lithium metal (with a thickness of 0.3 mm) was used as a negative electrode. As a solvent for dissolving an electrolyte, a solvent containing ethylene carbonate (EC) and ethyl methyl carbonate (EMC) mixed in a volume ratio of 1:3 was used. Lithium hexafluorophosphate as an electrolyte was dissolved in this solvent at a concentration of 1.25 mol/L to obtain an electrolyte solution.

This electrolyte solution was impregnated into a porous polyethylene sheet (with a thickness of 20 μm) as a separator, the positive electrode, and the negative electrode. The separator, the positive electrode, and the negative electrode were placed in a coin-type battery case, as configured in FIG. 1. The opening of the case was covered with a sealing plate provided with a gasket, and then the case was crimped thereon and sealed with a press machine. The coin-type lithium primary battery of Example 1 was obtained in this way.

### Example 2

In Example 2, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and a polymer Y shown in Formula (16), i.e., a quinone compound, was used as the second active material. The polymer Y is a reduced form of the nolvmer X.

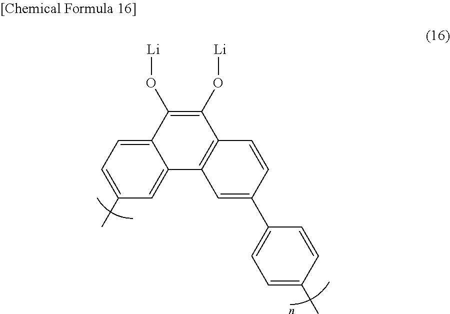

First, the polymer X was subjected to reduction treatment. That is, the polymer X was dissolved in N-methylpyrrolidone, and then subjected to reduction treatment by immersion in an aqueous solution of Li₂CO₃. Thus, the polymer Y represented by Formula (16) was obtained. Next, 15 mg of the polymer Y, 15 mg of graphite fluoride (CF)ₙ, and 80 mg of acetylene black as a conductive agent were weighed, and put into a mortar and mixed. Furthermore, 20 mg of polytetrafluoroethylene as a binder was added and mixed in the mortar. The mixture thus obtained was press-bonded onto a stainless steel mesh (30 mesh, manufactured by the Nilaco Corporation) as a current collector by means of a roller, vacuum-dried, and stamped into a disk shape with a diameter of 16 mm. Thus, a positive electrode was prepared. The weights of graphite fluoride and the polymer Y as the active materials contained in this positive electrode were 1.5 mg and 1.5 mg, respectively.

Except that this positive electrode was used, the coin-type lithium primary battery of Example 2 was obtained in the same manner as in Example 1.

### Example 3

In Example 3, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and a polymer shown in Formula (17), i.e., a tetraketone compound, was used as the second active material. In Formula (17), the ratio of m and n, each representing the number of repeating units, was 50:50. The weight average molecular weight of the polymer of Formula (17) was 49840 in terms of polystyrene, and the polymerization degree thereof was 112. The synthesis method of the polymer of Formula (17) is described in detail in WO 2011/111401 A1, for example. Except that a different type of second active material was used, the coin-type lithium primary battery of Example 3 was obtained in the same manner as in Example 1. The open circuit potential of the polymer of Formula (17) at 0% DOD was 3.05 V. The polymer of Formula (17) had two plateaus during discharge. The discharge potentials of these plateaus were 2.80 V and 2.28 V, respectively. This means that the average discharge potential of these two plateaus was 2.54 V.

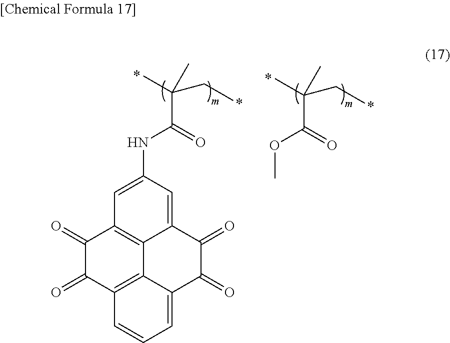

### Example 4

In Example 4, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and a polymer shown in Formula (18), i.e., a paraquinone compound, was used as the second active material. In Formula (18), the ratio of m and n, each representing the number of repeating units, was 50:50. The weight average molecular weight of the polymer of Formula (18) was 50350 in terms of polystyrene, and the polymerization degree thereof was 120. The polymer shown in Formula (18) can be synthesized using 2-aminoanthraquinone as a starting material in the same manner as for the polymer shown in Formula (17). Except that a different type of second active material was used, the coin-type lithium primary battery of Example 4 was obtained in the same manner as in Example 1. The open circuit potential of the polymer of Formula (18) at 0% DOD was 3.02 V. The polymer of Formula (18) had two plateaus during discharge. The discharge potentials of these plateaus were 2.33 V and 2.20 V, respectively. The average discharge potential of the polymer of Formula (18) was 2.26V.

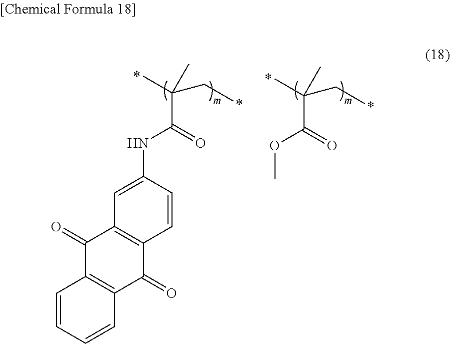

In Example 5, a coin-type lithium primary battery shown in FIG. 1 was produced using, as positive electrode active materials, a first active material capable of absorbing lithium ions and a second active material capable of absorbing and desorbing lithium ions. Manganese dioxide (MnO₂) was used as the first active material, and the polymer shown in Formula (17) was used as the second active material. Except that a different type of first active material and a different type of second active material were used, the coin-type lithium primary battery of Example 5 was obtained in the same manner as in Example 1. The open circuit potential of manganese dioxide (MnO₂) at 0% DOD was 3.69 V and the average discharge potential thereof was 2.76 V.

### Comparative Example 1

In Comparative Example 1, a coin-type lithium primary battery shown in FIG. 1 was produced using only a first active material capable of absorbing lithium ions as a positive electrode active material. Graphite fluoride (CF)ₙ was used as the first active material.

30 mg of graphite fluoride (CF)ₙ and 80 mg of acetylene black as a conductive agent were weighed and mixed in a mortar. Furthermore, 20 mg of polytetrafluoroethylene as a binder was added and mixed in the mortar. The mixture thus obtained was press-bonded onto a stainless steel mesh (30 mesh, manufactured by the Nilaco Corporation) as a current collector by means of a roller, vacuum-dried, and stamped into a disk shape with a diameter of 16 mm. Thus, a positive electrode was prepared. The weight of graphite fluoride as the active material contained in this positive electrode was 3.0 mg.

Except that this positive electrode was used, the coin-type non-aqueous electrolyte primary battery of Comparative Example 1 was obtained in the same manner as in Example 1.

### Comparative Example 2

In Comparative Example 2, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and a radical polymer Z shown in Formula (19) below was used as the second active material. The radical polymer Z is a nitroxide radical, and a reduced form (discharged form) of an oxoammonium cation. The open circuit potential of this oxioammonium cation was 3.6 V.

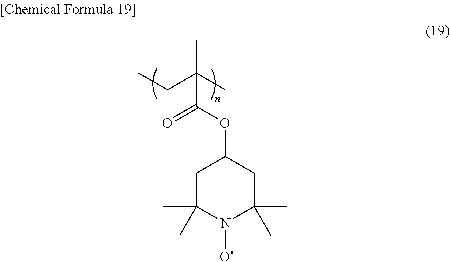

15 mg of the radical polymer Z, 15 mg of graphite fluoride (CF)ₙ, and 80 mg of acetylene black as a conductive agent were weighed, and put into a mortar and mixed. Furthermore, 20 mg of polytetrafluoroethylene as a binder was added and mixed in the mortar. The mixture thus obtained was press-bonded onto a stainless steel mesh (30 mesh, manufactured by the Nilaco Corporation) as a current collector by means of a roller, vacuum-dried, and stamped into a disk shape with a diameter of 16 mm. Thus, a positive electrode was prepared. The weights of graphite fluoride and the radical polymer Z as the active materials contained in this positive electrode were 1.5 mg and 1.5 mg, respectively.

Except that this positive electrode was used, the coin-type lithium primary battery of Comparative Example 2 was obtained in the same manner as in Example 1.

### Comparative Example 3

In Comparative Example 3, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and lithium cobalt oxide (LiCoO₂) was used as the second active material. Lithium cobalt oxide is a reduced form (discharged form) of an oxidized form of lithium cobalt oxide (Li_{0.5}CoO₂) used in Comparative Example 4 described later.

15 mg of lithium cobalt oxide (LiCoO₂), 15 mg of graphite fluoride (CF)ₙ, and 80 mg of acetylene black as a conductive agent were weighed, and put into a mortar and mixed. Furthermore, 20 mg of polytetrafluoroethylene as a binder was added and mixed in the mortar. The mixture thus obtained was press-bonded onto a stainless steel mesh (30 mesh, manufactured by the Nilaco Corporation) as a current collector by means of a roller, vacuum-dried, and stamped into a disk shape with a diameter of 16 mm. Thus, a positive electrode was prepared. The weights of graphite fluoride and lithium cobalt oxide as the active materials contained in this positive electrode were 1.5 mg and 1.5 mg, respectively.

Except that this positive electrode was used, the coin-type lithium primary battery of Comparative Example 3 was obtained in the same manner as in Example 1.

### Comparative Example 4

In Comparative Example 4, a coin-type lithium primary battery shown in FIG. 1 was produced using, as positive electrode active materials, a first active material capable of absorbing lithium ions and a second active material capable of absorbing and desorbing lithium ions. Graphite fluoride (CF)ₙ was used as the first active material, and an oxidized form of lithium cobalt oxide (Li_{0.5}CoO₂) was used as the second active material. The open circuit potential of the ozidized form of lithium cobalt oxide was 4.2 V

First, lithium cobalt oxide (LiCoO₂) was immersed in an aqueous potassium thiosulfate solution with a concentration of 14 g/L for chemical oxidation to obtain an oxidized form of lithium cobalt oxide (Li_{0.5}CoO₂). Next, 15 mg of the oxidized form of lithium cobalt oxide, 15 mg of graphite fluoride (CF)ₙ, and 80 mg of acetylene black as a conductive agent were weighed, and put into a mortar and mixed. Furthermore, 20 mg of polytetrafluoroethylene as a binder was added and mixed in the mortar. The mixture thus obtained was press-bonded onto a stainless steel mesh as a current collector by means of a roller, vacuum-dried, and stamped into a disk shape with a diameter of 16 mm. Thus, a positive electrode was prepared. The weights of graphite fluoride and the oxidized form of lithium cobalt oxide as the active materials contained in this positive electrode were 1.5 mg and 1.5 mg, respectively.

Except that this positive electrode was used, the coin-type lithium primary battery of Comparative Example 4 was obtained in the same manner as in Example 1.

[Evaluation of Discharge Characteristics of Batteries]

The discharge characteristics of the coin-type lithium primary batteries obtained in Examples 1 to 5 and Comparative Examples 1 to 4 were evaluated in the following manner. All these tests were performed on each battery in a temperature-controlled chamber environment at 25° C.

The discharge capacities of the batteries of Examples 1 to 5 and Comparative Examples 1 to 4 were evaluated. For the evaluation of the discharge capacities, the discharge capacity of each of the batteries was measured by discharging the battery at a constant current value equivalent to a 20-hour rate current (i.e., 0.05 CmA) with respect to the design capacity of the battery. The lower limit discharge voltage was set to 2.0 V.

The batteries of Examples 1 to 5 each had a discharge capacity as designed. The outputs (pulse discharge characteristics) of the batteries of Examples 1 to 5 and Comparative Examples 1 to 4 were evaluated. For the evaluation of the outputs (pulse discharge characteristics), the maximum current values, at which 5-second discharge could be observed, were measured at 0%, 25%, 50%, and 75% depths of discharge (DOD) of each of the batteries. The battery was discharged at a constant current value equivalent to a 20-hour rate current (i.e., 0.05 CmA) with respect to the discharge capacity obtained as a result of the above discharge capacity evaluation. The lower limit discharge voltage was set to 2.0 V. First, the battery was left as it was after the assembly thereof was completed and then discharged to measure the maximum current value at 0% DOD. The battery was discharged for 5 hours, followed by a 10-hour interruption. Then, the discharge was started again to measure the maximum current value at 25% DOD. The 5-hour discharge and 10-hour interruption were alternately repeated in the same manner to measure the maximum current values at 50% DOD and 75% DOD.

Table 1 collectively shows the results of the discharge capacity evaluation and the output evaluation.

TABLE 1

| | Discharge | Output [mA] | | | |
|---|---|---|---|---|---|
| | capacity | | | | 75% |
| | [mAh] | 0% DOD | 25% DOD | 50% DOD | DOD |
| Example 1 | 1.4 | 14 | 12 | 12 | 12 |
| Example 2 | 1.1 | 12 | 12 | 12 | 12 |
| Example 3 | 1.6 | 16 | 14 | 14 | 14 |
| Example 4 | 1.4 | 14 | 13 | 10 | 10 |
| Example 5 | 0.5 | 5 | 4 | 4 | 4 |
| Com. Example 1 | 2.3 | 2 | 5 | 8 | 8 |
| Com. Example 2 | 1.1 | 2 | 5 | 7 | 7 |
| Com. Example 3 | 1.1 | 2 | 4 | 7 | 6 |
| Com. Example 4 | 1.3 | 10 | 5 | 8 | 7 |

As shown in Table 1, the output of the battery of Comparative Example 1 was low because only graphite fluoride was used as a positive electrode active material. In particular, the output at 0% DOD was 2 mA, which was the lowest current value, because graphite fluoride has low electron conductivity at an early stage of a discharge reaction.

On the other hand, the batteries of Example 1 and Example 2 each exhibited higher outputs than those of the battery of Comparative Example 1 at all depths of discharge (DOD) because the first active material and the second active material were used as positive electrode active materials and a quinone compound was used as the second active material. The open circuit potential of graphite fluoride (CF)ₙ is 3.15 V, and the average discharge potential thereof is 2.55 V. The open circuit potential of the polymer X is 3.05 V. Therefore, in each of Examples 1 and 2, the open circuit potential (3.05 V) of the second active material is lower than the open circuit potential (3.15 V) of the first active material and higher than the average discharge potential (2.55 V) of the first active material. As can be understood from the following description, the design capacity of the quinone compound (second active material) relative to the total design capacity of the positive electrode of the battery in each of Example 1 and Example 2 is as low as 21% (0.3 mAh/1.4 mAh). High outputs could be obtained at all depths of discharge (DOD) in spite of such a low content of the quinone compound because while the battery was left in the open circuit state, the quinone compound in the discharged state was charged by graphite fluoride into a dischargeable state again.

In Example 2, the quinone compound was in the reduced state (discharged state) when the assembly of the battery was completed, while in Example 1, the quinone compound was in the oxidized state (charged state) when the assembly of the battery was completed. As a result, the battery of Example 1 exhibited a higher discharge capacity than the battery of Example 2. As just described, a higher energy density can be obtained by the addition of the second active material in the charged state during the assembly of the battery. Specifically, in each of Examples 1 and 2, the design capacities of graphite fluoride and the quinone compound were 1.1 mAh and 0.3 mAh, respectively. The discharge capacity of the battery of Example 2 was 1.1 mAh, which was equal to the design capacity of graphite fluoride, while the discharge capacity of the battery of Example 1 was 1.4 mAh, which was equal to the total design capacity of graphite fluoride and the quinone compound.

In Examples 3 and 4, as in Example 1, higher outputs than Comparative Example 1 could be obtained. The open circuit potential of graphite fluoride (CF)ₙ is 3.15 V, and the average discharge potential thereof is 2.55 V. The open circuit potential of the polymer of Formula (17) is 3.05 V. The open circuit potential of the polymer of Formula (18) is 3.02 V. Therefore, in each of Examples 3 and 4, the open circuit potential of the second active material is lower than the open circuit potential (3.15 V) of the first active material and higher than the average discharge potential (2.55 V) of the first active material. The design capacity of the quinone compound (second active material) relative to the total design capacity of the positive electrode of the battery in Example 3 is as low as 22% (0.36 mAh/1.6 mAh), and that in Example 4 is as low as 14% (0.20 mAh/1.4 mAh). High outputs could be obtained at all depths of discharge (DOD) in spite of such a low content of the quinone compound because while the battery was left in the open circuit state, the quinone compound in the discharged state was charged by graphite fluoride into a dischargeable state again. Furthermore, since the high-capacity second active material (a polymer having a repeating unit with a tetraketone skeleton) was used in Example 3, the battery of Example 3 had a high discharge capacity. The maximum current value at each DOD of the battery of Example 3 was greater than the maximum current value at each DOD of the battery of Example 4.

High outputs could be obtained also in Example 5. The open circuit potential of manganese dioxide (MnO₂) at 0% DOD was 3.69 V, and the average discharge potential thereof was 2.76 V. When a lithium primary battery having a discharge capacity of 0.5 mAh was produced using only manganese dioxide (MnO₂) as a positive electrode and tested in the same manner as in Example 5, a current of only about 0.2 mA could be drawn at 0% DOD. In contrast, in Example 5, high currents could be obtained at all depths of discharge for the tests. The reasons for this are probably as follows.

The open circuit potential of the polymer of Formula (17) is 3.05 V, which is lower than the open circuit potential (3.69 V) of manganese dioxide and higher than the average discharge potential (2.76 V) of manganese dioxide. The resistance of manganese dioxide during a discharge reaction is relatively high. Therefore, if a large current is drawn from a lithium primary battery using only manganese dioxide as a positive electrode, the potential of manganese dioxide drops sharply to the lower limit potential of 2.0 V. In contrast, in the battery of Example 5 using the polymer of Formula (17) and manganese dioxide in combination, the polymer of Formula (17) is responsible for a large current discharge and then manganese dioxide is discharged. As a result, a large current can be drawn. High outputs could be obtained at all depths of discharge (DOD) in spite of such a low content of the quinone compound because while the battery was left in the open circuit state, the quinone compound in the discharged state was charged by manganese dioxide into a dischargeable state again.

A comparison between the battery of Example 3 and the battery of Example 5 showed that they exhibited comparable performance in terms of output characteristics. With regard to the pulse characteristics after a 3-month storage, Example 3 exhibited better characteristics than Example 5. As just described, Example 3 including the first active material and the second active material, both of which were organic materials, exhibited good performance in terms of long-term reliability

A comparison between Example 3 and Example 4 showed that they exhibited comparable output characteristics at 0% to 25% DOD. However, at 50% or more DOD, the output characteristics of the battery of Example 4 using a paraquinone compound decreased. Probably, this phenomenon is caused by the following two factors. The first factor is that the average discharge potential of the paraquinone compound of Formula (18) is lower than that of an orthoquinone compound typified by Formula (17). The average discharge potential of the paraquinone compound of Formula (18) was 2.26V. Since the lower limit voltage set for the discharge test is 2.0 V, the discharge potential of the paraquinone compound drops to the lower limit voltage at a large current discharge, resulting in a difficulty in discharging with a large current. Another factor is the difference in charge-discharge reversibility between the paraquinone compound and the orthoquinone compound. Since the orthoquinone compound has a good charge-discharge cycle efficiency, it is charged efficiently by the first active material. In contrast, for structural reasons, the paraquinone compound is charged by the first active material with a slightly lower efficiency than the orthoquinone compound. A combination of these factors caused a decrease in the output characteristics at 50% or more DOD in Example 4.

When a large current is drawn from a battery, the battery has a high overvoltage due to its internal resistance, resulting in a drop in the potential. When considering the lower limit operating voltage of a device equipped with a lithium primary battery, the lower limit operating voltage of the battery is set to about 2.0 V. Therefore, it is substantially useless to obtain good output characteristics at 2.0 V or less, and it is necessary to draw a current at 2.0 V or more. In this case, it is effective to use a second active material having an average discharge potential as high as possible but lower than the open circuit potential of a first active material. From this viewpoint, it is desirable to use an orthoquinone compound rather than a paraquinone compound having a lower average discharge potential. Furthermore, it is desirable that the average discharge potential of the second active material be between the average discharge potential of the first active material and the open circuit potential of the first active material. In this case, the second active material having better current characteristics is discharged first, which makes it possible to draw a large current efficiently.

In the battery of Comparative Example 4, a first active material and a second active material were used as positive electrode active materials and an oxidized form of lithium cobalt oxide was used as the second active material. Therefore, the discharge capacity was 1.3 mAh, which was higher than the design capacity (1.1 mAh) of graphite fluoride as the first active material, and a relatively high output was obtained at 0% DOD, but the output decreased at 25% or more DOD. The open circuit potential of the oxidized form of lithium cobalt oxide (Li_{0.5}CoO₂) as the second active material in the battery of Comparative Example 4 is 4.2 V, which is higher than the open circuit potential (3.15 V) of the first active material. The high output effect of the oxidized form of lithium cobalt oxide could be obtained only at 0% DOD because the second active material (lithium cobalt oxide) once discharged was not automatically charged by graphite fluoride. Such a battery is not adequate as a high-output lithium primary battery. Rechargeability of the once-discharged second active material in the battery is the key to obtaining high outputs at all depths of discharge.

The second active material used in Comparative Example 3 was lithium cobalt oxide and was in the discharged state (reduced state). As in the case of Comparative Example 4, the lithium cobalt oxide was not automatically charged by graphite fluoride. Therefore, in the battery of Comparative Example 3, the high output effect could not be obtained even at 0% DOD, and the discharge capacity was 1.1 mAh, which was equal to the design capacity of the first active material (graphite fluoride).

The second active material used in Comparative Example 2 was a radical polymer Z and was in the discharged state (reduced state). The open circuit potential of an oxoammonium cation which is a charged form (oxidized form) of the radical polymer Z is 3.6 V, which is higher than the open circuit potential (3.15 V) of the first active material. Since the potential at which the radical polymer Z is charged is much higher than the open circuit potential of the first active material, the radical polymer Z as the first active material was not automatically charged by graphite fluoride. Therefore, in the battery of Comparative Example 2, the high output effect could not be obtained, and the discharge capacity was equal to the design capacity of the first active material (graphite fluoride).

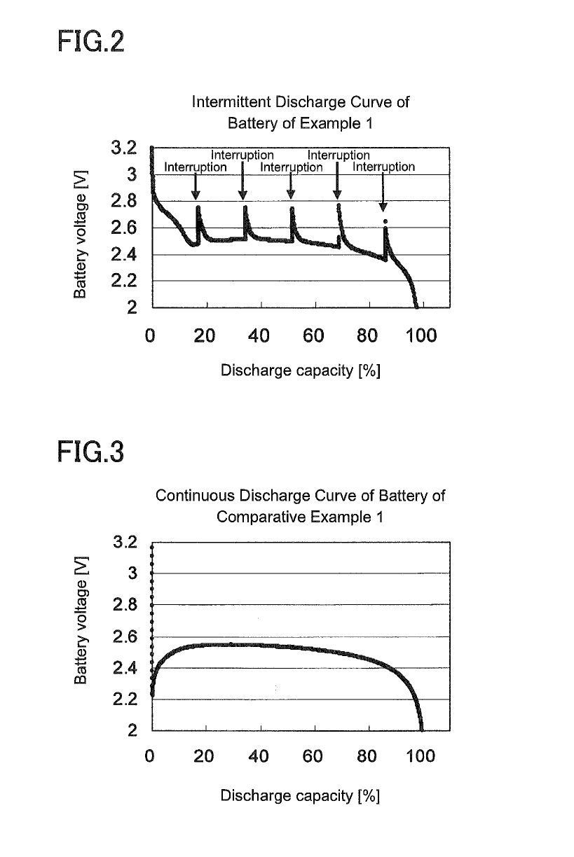

An intermittent discharge test was performed on the coin-type lithium primary battery obtained in Example 1. An operation of discharging the battery for 3 hours at a current equivalent to a 18-hour rate (i.e., 0.055 CmA) and then interrupting the discharge for 12 hours was repeated to obtain an intermittent discharge curve. The lower limit discharge voltage was set to 2 V. FIG. 2 show the result. For comparison, a continuous discharge test was performed on the coin-type lithium primary battery obtained in Comparative Example 1. The battery was discharged at a current equivalent to a 18-hour rate (0.055 CmA), with the lower limit discharge voltage being set to 2 V, to obtain a continuous discharge curve. FIG. 3 shows the result.

As shown in FIG. 3, in the battery of Comparative Example 1, a significant voltage drop derived from the material properties of graphite fluoride was observed at 0 to 17% DOD. In contrast, in the battery of Example 1 containing a quinone compound, a significant voltage increase was observed at 0 to 17% DOD, as shown in FIG. 2. These facts show that the addition of the quinone compound contributes to an increase in the voltage and an increase in the output at an early stage of the discharge. Furthermore, as shown in FIG. 2, an increase in the discharge voltage was observed at all 17%, 33%, 50%, 67%, and 83% DOD after the discharge of the battery was interrupted, that is, after the battery was left in the open circuit state. This means that the discharged quinone compound was recharged by graphite fluoride and thereby the voltage was increased. From the above results, it was confirmed that a quinone compound is recharged by graphite fluoride repeatedly and can be discharged at any depth of discharge at the start of discharge, and thus a lithium primary battery capable of exhibiting a high output repeatedly each time it is used.

### INDUSTRIAL APPLICABILITY

The lithium primary battery of the present invention has a high capacity and high output characteristics. In particular, since the lithium primary battery of the present invention has excellent pulse discharge characteristics, it can be suitably used for various mobile devices that require an instantaneous large current.

1-14. (canceled)

15. A lithium primary battery comprising a positive electrode comprising a first active material capable of absorbing a lithium ion and a second active material capable of absorbing and desorbing a lithium ion, wherein
the second active material is a polymer of a compound having a cyclic skeleton having carbon atoms at least two of which each form a ketone group, and the cyclic skeleton forms a conjugated system together with the at least two ketone groups, and
the second active material is automatically charged by the first active material while the lithium primary battery is in an open circuit state.

16. The lithium primary battery according to claim 15, wherein the second active material is in a charged state when assembly of the lithium primary battery is completed.

17. The lithium primary battery according to claim 15, wherein the polymer comprises a repeating unit having a phenanthrenequinone skeleton or a tetraketone skeleton.

18. The lithium primary battery according to claim 15, wherein
the positive electrode further comprises a conductive agent, and
the polymer as the second active material is present in a form of a thin film that covers a surface of the conductive agent.

19. The lithium primary battery according to claim 15, wherein the first active material is graphite fluoride or manganese dioxide.

20. The lithium primary battery according to claim 15, wherein an open circuit potential of the second active material at 0% depth of discharge relative to a lithium electrode is lower than an open circuit potential of the first active material at 0% depth of discharge relative to the lithium electrode.

21. The lithium primary battery according to claim 20, wherein the open circuit potential of the second active material at 0% depth of discharge relative to the lithium electrode is higher than an average discharge potential of the first active material relative to the lithium electrode.

22. The lithium primary battery according to claim 15, wherein an average discharge potential of the second active material is equal to or less than an open circuit potential of the first active material at 0% depth of discharge and is 2.0 V or more relative to a negative electrode of the lithium primary battery.

23. The lithium primary battery according to claim 15, wherein the polymer is a polymer represented by Formula (15) below:

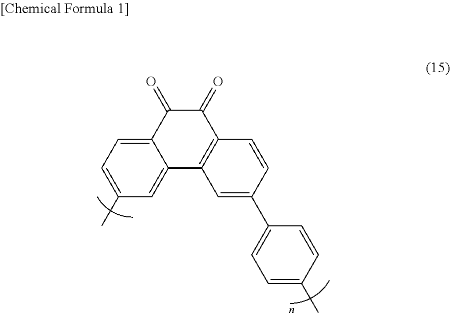

24. The lithium primary battery according to claim 15, wherein the polymer is a polymer represented by Formula (16) below:

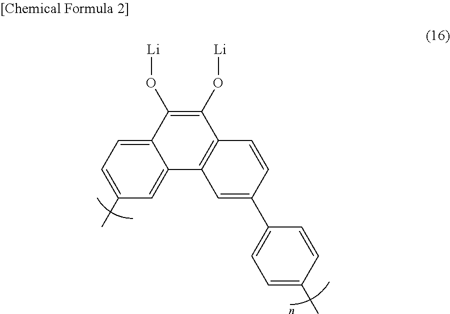

25. The lithium primary battery according to claim 15, wherein the polymer is a polymer represented by Formula (17) below: [chemical structure]
